(19) United States
(12) Patent Application Publication
(10) Pub. No.: US 2004/0121208 A1
(43) Pub. Date: Jun. 24, 2004

(54) Tubular direct methanol fuel cell

(76) Inventors: Doug James, Calgary (CA); Partho Sarkar, Edmonton (CA); Karl Kordesch, The Plains, OH (US); Gary Kovacik, Edmonton (CA)

Correspondence Address: GOWLING LAFLEUR HENDERSON LLP, P.O. BOX 49122, 2300-1055 DUNSMUIR ST., VANCOUVER, BC, V7X 1J1, CA

(21) Appl. No.: 10/326,309

(22) Filed: Dec. 23, 2002

(51) Int. Cl. H01M 8/10

(52) U.S. Cl. 429/31

(57) ABSTRACT

This invention relates to a tubular direct methanol fuel cell. The fuel cell includes: a tubular inner electrode, a tubular outer electrode located concentrically around the inner electrode, and an annular electrolyte conduit located concentric to and in between the inner and outer electrodes. The inside of the inner electrode is a reactant conduit that is fluidly communicable with a first reactant source such that a first reactant is transmittable therethrough. The outside surface of the outer electrode is fluidly communicable with a second reactant source such that a second reactant is transmittable over the outside surface of the outer electrode. The annular electrolyte conduit is fluidly communicable with a fluid electrolyte source such that a fluid electrolyte is transmittable therethrough. One reactant is methanol-containing fuel, and the other reactant is oxidant.

### FIELD OF THE INVENTION

This invention relates generally to fuel cells and in particular to direct methanol fuel cells (DMFC).

### BACKGROUND OF THE INVENTION

A DMFC uses methanol directly as a reducing agent, similar to how hydrogen acts as the reducing agent for a direct hydrogen fuel cell (DHFC), to produce electrical energy. Methanol is a promising fuel for fuel cell powered vehicles and other devices, as it is stable and liquid at ambient temperatures. For a DHFC system that uses methanol as a fuel source, a reformer must be provided to extract hydrogen from the methanol for use in the DHFC. Such fuel cells systems are known as “indirect” methanol fuel cell systems.

In contrast, in a direct fuel cell, and in particular a DMFC, liquid or vaporized methanol is supplied directly to the fuel cell without reforming. Therefore, the cost and complexity of providing reformer components in the system is avoided. The following redox reactions occur in a DMFC:

CH₃OH+H₂O→6H⁺+CO₂+6e⁻ Anode:

1½O₂+6H⁺+6e⁻→3H₂O Cathode:

Yielding the net reaction:

1½O₂+CH₃OH→2H₂O+CO₂

The redox reactions result in the production of protons and electrons at the anode. The anode and cathode are electrically connected, through an external load, to provide a path for the electrons to flow from the anode to the cathode. A proton-conducting electrolyte is provided between the electrodes to enable the flow of protons from the anode to the cathode.

It is known for fuels other than methanol to be used in direct fuel cells. Such fuels may include other simple alcohols, such as ethanol, dimethoxymethane, trimethoxymethane, and formic acid. Also, other oxidants other than air may be used, such as an organic fluid having a high oxygen content or hydrogen peroxide solution.

The electrolyte used in fuel cells may be either liquid or solid. In the case of a solid electrolyte, a proton exchange membrane (PEM) may be used and may be for example, a hydrated sheet of a perfluorinated ion exchange membrane such as a polyperfluorosulfonic acid membrane, one commercial example being NAFION® sold by E.I. du Pont de Nemours and Co.

In any of the fuel cells mentioned above, it is important to maintain a separation between the anode and the cathode so as to prevent fuel from directly contacting the cathode and oxidizing thereon. For this reason, PEMs, although functioning well as proton exchangers and/or solid electrolytes, are not as efficient as fuel separators, and a common problem in PEM fuel cells is the incidence of fuel cross over, which occurs when the fuel, prior to oxidation, diffuses through the membrane and contacts the cathode. Apart from the parasitic loss of fuel and oxidant from the system, such cross-over results in a short circuit in the cell since the electrons resulting from the oxidation reaction do not follow the current path between the electrodes. Further, other disadvantages of fuel cross over may include structural changes on the cathode surface (e.g. sintering) and poisoning of the reduction catalyst by fuel oxidation products.

Several approaches to addressing the cross-over and other problems in DMFC have been published. Once such approach is disclosed in PCT application WO 01/39307, which discloses a DMFC with a circulating aqueous electrolyte. The application proposes that controlling the speed of electrolyte circulation controls the build-up of the cross-over gradient in the fuel cell. Also, methanol that has permeated into the electrolyte can be reclaimed in a distillation loop.

### SUMMARY OF THE INVENTION

It is an object of the invention to provide a DMFC system that improves upon the state of the art. One specific objective is to provide improvements to a DMFC system that uses a circulating aqueous electrolyte. Another specific objective is to provide an improved geometric configuration for a DMFC that enables the relative areas of cathode and anode to be scaled up or down depending on the operating requirements of the fuel cell.

According to one aspect of the invention, there is provided a direct methanol fuel cell comprising:

(a) a tubular inner electrode, the inside of which is a reactant conduit that is fluidly communicable with a first reactant source such that a first reactant stream is transmittable therethrough;

(b) a tubular outer electrode located concentrically around the inner electrode, the outside surface of which is fluidly communicable with a second reactant source such that a second reactant stream is transmittable over the outside surface of the outer electrode; and

(c) an annular electrolyte conduit located concentric to and in between the inner and outer electrodes, and being fluidly communicable with a fluid electrolyte source such that a fluid electrolyte stream is transmittable therethrough.

One reactant is methanol-containing fuel, and the other reactant is oxidant. The tubular design of the anode and cathodes enables their relative areas to be scaled up or down depending on the operational requirements of the fuel cell. In particular, catalyst utilization typically is reduced at higher loadings relative to lower loadings and therefore the cost of the catalyst will increase disproportionately to the increased catalyst loading (ie activity is not a linear function of the loading). Since the cathode may be more active than the anode for a particular catalyst type or catalyst loading, or vice versa, it is advantageous to keep the catalyst loadings constant and as low as possible, and vary the area of the electrodes. This increases utilization of the catalyst and reduces cost. The concentric tubular design provides this design flexibility, which is not available in planar designs.

The inner electrode may be an anode, and the outer electrode a cathode; in such a case, the first reactant is the fuel and the second reactant is the oxidant. Alternatively, the inner electrode may be a cathode, and the outer electrode an anode; in such a case, the first reactant is the oxidant and the second reactant is the fuel.

The fuel cell may further comprise a tubular proton-conducting, substantially reactant and electrolyte impermeable membrane separator located concentric to and between the anode and cathode. The membrane separator may be spaced apart from one of the electrodes to form an annular electrolyte conduit therebetween. For example, the electrolyte conduit may be between the separator and the cathode. The electrolyte conduit is fluidly communicable with an electrolyte source such that a fluid electrolyte is transmittable therethrough, and in particular, can be circulated between the electrolyte source and the electrolyte conduit. The membrane may be selected from the group of perfluorinated proton exchange membrane, microporous plastic membranes, carbon tubes, ceramic tubes, asbestos-based membranes, or any other material serving the function of a semi-permeable separator.

The anode may be substantially fuel permeable. In such a case, the fuel conduit has an inlet for the flow of fuel into the fuel cell and the fuel cell further comprises an annular fuel discharge conduit concentric to and between the anode and the separator with a fuel outlet for the flow of permeated fuel and anode reaction products out of the fuel cell. In particular, the fuel cell may be closed to fuel flow at one end, and the fuel inlet and fuel outlet may be located at the other end.

Alternatively, the anode may be substantially fuel impermeable. In such a case, the fuel cell further comprises an annular second electrolyte conduit concentric to and between the anode and separator for the flow of a second fluid electrolyte stream therethrough.

### BRIEF DESCRIPTION OF DRAWINGS

FIG. 1 is a schematic side view of a tubular direct methanol fuel cell having an inner anode tube with high fuel permeability, and an outer cathode tube.

FIG. 2 is a schematic side view of a tubular direct methanol fuel cell having an inner cathode tube, and an outer anode tube with high fuel permeability.

FIG. 3 is a schematic side view of a tubular direct methanol fuel cell having an inner anode tube with low fuel-permeability, an outer cathode tube, and a membrane separator in between the anode and cathode tubes.

FIG. 4 is a schematic side view of a tubular direct methanol fuel cell similar to the fuel cell shown in FIG. 3 but without a membrane separator in between the anode and cathode tubes.

FIG. 5 is a schematic side view of a tubular direct methanol fuel cell having an inner cathode tube, an outer anode tube with low permeability, and a separator membrane between the anode and cathode tubes.

FIG. 6 is a schematic side view of a tubular direct methanol fuel cell similar to the fuel cell shown in FIG. 5 but without a membrane separator in between the anode and cathode tubes.

### DETAILED DESCRIPTION

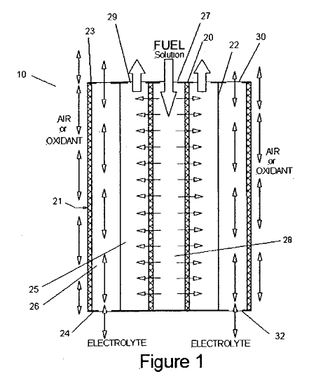

Referring to FIG. 1 and according to a first embodiment of the invention, a tubular DMFC fuel cell 10 comprises a tubular fuel electrode 20 (anode), a tubular separation membrane 22 concentric to and outside of the anode 20, and a tubular air electrode 21 (cathode) concentric to and spaced outside of the separation membrane 22. The anode 20, separation membrane 22, and cathode 21 are capped at each end by first and second end caps 23, 24. Although not shown in FIG. 1, the electrodes 20, 21 are electrically connected to an external circuit as known in the art, to conduct the flow of electrons generated in the fuel cell 10.

The diameters of the anode 20, separation membrane 22, and cathode 21 are selected to provide annular channels in between the anode and separation membrane (defined hereafter as “fuel discharge channel” 25) and in between the separation membrane and cathode (defined hereafter as “electrolyte channel” 26). The first end cap 23 has a generally circular fuel inlet 27 that is in fluid flow communication with the inside of the anode 20 (“fuel feed channel” 28), an annular fuel outlet 29 in fluid flow communication with the fuel discharge channel 25, and, an annular electrolyte opening 30 in fluid flow communication with the electrolyte channel 26.

The second end cap 24 has an annular electrolyte flow opening 32 in fluid flow communication with the electrolyte channel 26. The second end cap 24 is closed to the fuel feed channel 28 and the fuel discharge channel 25.

The electrodes 20, 21 are formed from DMFC electrode materials as known in the art, such as activated carbon tubes or composite carbon tubes formed from activated carbon or carbon-based materials such as carbon cloth, carbon fibers, graphite, and binders. Other suitable materials for the electrodes include ceramics, polymers, metals or other semi-permeable substances or structures. The electrodes could also be made of composite materials such as formed, sprayed or layered PTFE bonded porous tubes on woven carbon (graphite) sheets or fleece, or other composite materials as would be used in planar electrodes. The thickness of the electrodes 20, 21 are selected such that the electrodes 20, 21 are self-supporting; however, the fuel cell 10 may be optionally provided with a support structure such as a porous ceramic, polymer or stainless steel grid or foam-like matrix or similar supporting structure located within either or both of the two electrode tubes (not shown in the figure). such support structures are particularly desirable when the electrode walls are thin and do not have significant structural integrity. An example of such supported electrode is a stainless steel screen supported plate (foil) structure layered with mixtures of activated carbon and suitable catalyst and pore forming fillers (e.g. bicarbonates) or repellent binders (e.g. PTFE or PE).

The electrodes 20, 21 are porous. The porosity of the electrodes 20, 21 can be controlled through the admixture of or coating with polytetrafluoroethylene (PTFE), Nafion® or other materials known to persons skilled in the art. The porosity of the anode 20 is in the order of 1% to 10% and thus is permeable to methanol fuel. The porosity of the cathode 21 is in the range of a normal 3-phase electrode and thus is permeable to air/oxidant but not to the electrolyte. The opposing surfaces of the electrodes 20 and 21 are coated with a thin catalyst layer for the purposes of catalyzing the oxidation and reduction reactions of the fuel cell 10. The catalyst material is preferably platinum (Pt), or a Pt and Ruthenium (Ru) combination. However, other catalysts may be used for the fuel cell 10, such as, other noble metals, molybdenum, Pt alloys, etc. and will be apparent to persons skilled in the art. The catalyst material is dispersed throughout the body of the electrodes 20 and 21; alternatively, the catalyst may be applied onto the surface of the electrodes 20, 21. In particular, the anode 20 may be coated with a 50/50 Pt/Ru mixture at a density of 1 mg/.sq cm² or less, while the cathode is coated with Pt at a density of 4 mg/sq cm² or less, or at the discretion of the person skilled in the art.

The walls of the electrodes 20, 21 may be coated with or annealed to a conductive material such as gold (not shown) to serve as a conductor for edge collection for those materials that are not sufficiently conductive to act as low resistance conductors in their own right. The amount of coating can be either the entire surface for low conductivity materials, or only selected regions, or with thin traces forming a grid or network to provide sufficient conductivity for moderately conductive materials.

The membrane separator 22 material is selectable from semi-permeable materials that perform the function of a mechanical separator that is substantially impermeable to liquid fuel and electrolyte and provide efficient proton conduction, as is known to practitioners of the art. Examples of such materials include Nafion®, Gore-Tex®, microporous plastic membranes, ceramic tubes, carbon tubes, etc.

The ratio of the anode and cathode diameters may be varied depending on the desired active area of the anode 20 relative to the active area of the cathode 21 to accommodate the different activities of the catalysts utilized. In particular, catalyst utilization typically is reduced at higher loadings relative to lower loadings and therefore the cost of the catalyst will increase disproportionately to the increased catalyst loading (i.e. activity is not a linear function of the loading). Since the cathode may be more active than the anode for a particular catalyst type or catalyst loading, or vice versa, it is advantageous to keep the catalyst loadings constant and as low as possible, and vary the area of the electrodes. This increases utilization of the catalyst and reduces cost. The concentric tubular design provides this design flexibility, which is not available in planar designs.

A suitable fuel used in the fuel cell 10 is a mixture of methanol in water with sulfuric acid. Alternatively, the fuel can be any of or combination of methanol, ethanol or other alcohols, glycols or similar compounds. Preferably, the methanol or other suitable fuel is in liquid form. A direct methanol liquid feed fuel cell has certain advantages over gas-feed fuel cells, including elimination of a fuel vaporizer and its associated heat source and controls, elimination of complex humidification and thermal management systems, and the use of a liquid methanol/water mixture as a fuel and as a stack coolant.

In operation, methanol fuel is flowed into the fuel cell 10 via the fuel inlet 27, and into the fuel feed channel 28. The fuel permeates through the porous anode 20 and is oxidized at the catalyst layer of the anode 20 to produce protons and other reaction products. Protons conduct from the anode through the fuel mixture in the fuel discharge channel 25, through the membrane separator 22, through the electrolyte solution in the electrolyte channel 26 and to the cathode 21 where they electrochemically react with oxidant. Electrons liberated in the electrochemical reaction at the anode 20 are conducted via an electrical connection (not shown) from the anode 20 through an external load (to do work), and return to the cathode 21. The flow rate of fuel into and out of the fuel cell 10 can be varied depending on the operating conditions; for example, for a fuel cell 10 in the order of about 10 ml internal volume, the fuel flow rate is about 2 ml per minute.

Any gases produced by the reaction at the anode 20 are removed from the fuel cell 10 via fuel discharge outlet 29 along with most of the unconsumed flowing fuel mixture. Since the second cap 24 is closed to the fuel feed channel 28 and the fuel discharge channel 25, the fuel is fed and discharged at the same end. The amount of unreacted fuel is typically about 90% of the fuel fed into the fuel cell 10. The separator membrane 22 provides a barrier and stops most of the unreacted fuel in the fuel discharge channel 25 from permeating into the electrolyte channel 26. Any fuel that may have crossed over into the electrolyte channel 26 is swept out of the fuel cell 10 by the flowing liquid electrolyte stream.

The liquid electrolyte is suitably a sulfuric acid mixture, but may also be any good conductive salt solution selected from the group of battery electrolytes with a pH of neutral to low acidic values, such as, KSCN, NH₄SCN, acidified K₂SO₄, or selected strong organic acids (Superacids). It is also possible to operate the fuel cell in a basic rather than acidic mode of operation, in which case the choices of electrolyte include potassium or sodium hydroxide, or other strongly dissociating bases. The electrolyte is flowed into the fuel cell 10 through the electrolyte opening 32 of the second end cap 24 and the electrolyte plus any methanol and other potentially damaging products leaked through the membrane separator 22 are flowed out through the electrolyte opening 30 of the first end cap 23. Because the liquid electrolyte is acidic, the fluid electrolyte does not impede the flow of protons from the anode to the cathode.

Alternatively, the electrolyte flow may be reversed, entering through the first cap electrolyte opening 30 and exiting through the second cap electrolyte opening 32. (Note: the arrows in FIG. 1 indicate fluid flows; unidirectional arrows indicate that the fluid flows in the direction indicated and bi-directional arrows indicate that the direction of fluid flow is discretional.)

The rate of flow of electrolyte is selected to carry out leaked (cross-over) methanol before it can reach the cathode 21. Factors that affect the rate of methanol cross-over include the electrolyte flow rate through electrolyte channel 26, the dimensions of the fluid channels inside the fuel cell 10, and the physical characteristics of the membrane separator 22 (e.g. porosity or permeability). The electrolyte flow rate can be varied depending on the operating conditions desired; typically, the electrolyte flow rate is set to exchange 2× to 5× the volume of electrolyte in the fuel cell 10 per minute.

The circulating electrolyte also serves as a heat management system as well as a water management system via circulating the electrolyte through exterior heat exchangers.

The fuel cell 10 may be located in a chamber that is supplied air for use as oxidant; in such case, the outside surface of the cathode is immersed in oxidant. Alternatively, the fuel cell 10 may be contained inside a cylindrical or other suitably shaped container (not shown) and oxidant is delivered to and discharged from the annular channel formed inside and between the container and the cathode.

Although not shown in FIG. 1, the first and second end caps 23, 24 are fluidly coupled to reservoirs, pumps, controls and other ancillary components of a fuel cell system as is known in the art. These components facilitate the delivery and removal of fuel, oxidant and electrolyte to and from the fuel cell 10. For example, the electrolyte inlet and outlet 30, 32 may be fluidly coupled to a methanol distillation recovery loop comprising an electrolyte storage tank, electrolyte pump and a separator (all not shown). Electrolyte is pumped from the storage tank and into the electrolyte conduit, wherein any leaked methanol is collected. The methanol and leaked methanol are then discharged from the electrolyte conduit and transmitted to the separator, wherein the electrolyte and methanol are separated as known in the art; the purified methanol is returned back the storage tank, and the recovered methanol is returned back the methanol supply source (e.g. a supply tank, not shown).

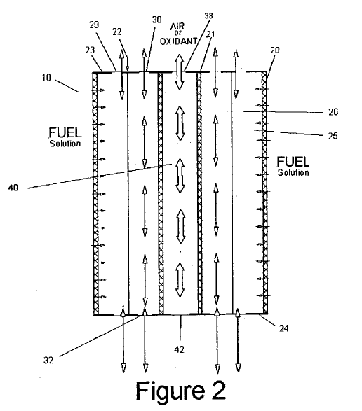

FIG. 2 illustrates another embodiment of the invention in which the anode 20 and cathode 21 are reversed in relative position, with the anode 20 becoming the outer tubular electrode, and the cathode 21 being the inner tubular electrode. In this embodiment, the assumption is made that the cathode catalyst is more efficient than the anode catalyst, so that a cathode with less surface area is required. As in the first embodiment, the membrane separator 22 is positioned between the two electrodes 20, 21. In this second embodiment, the fuel mixture is directed to the outside surface of the fuel cell 10, wherein fuel reacts at the anode 20; reaction products and unreacted fuel diffuse through the porous anode 20 into the fuel discharge channel 25 (between the membrane separator 22 and the anode 20) and is discharged from the fuel cell via fuel outlet 29. There may be fuel outlets in one or both end caps (a two ended outlet design is shown in FIG. 2). Air or oxidant is transmitted into the fuel cell 10 via an oxidant inlet 38 and into an oxidant flow channel 40 inside of the tubular cathode 21; reaction products and air are discharged from the fuel cell 10 through an oxidant outlet 42. The electrolyte is flowed into the fuel cell 10 through electrolyte opening 30 in the first cap 23 and out through electrolyte opening 32 in the second cap 24. Operation of the fuel cell 10 is otherwise the same as described in the first embodiment.

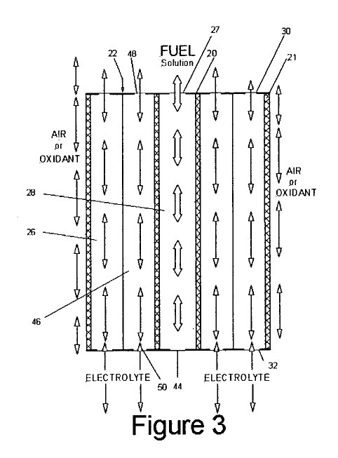

FIG. 3 illustrates a third embodiment of invention. This embodiment is a variation of the fuel cell 10 of the first embodiment and differs in that the anode 20 is substantially impermeable to the fuel, but is proton conductive. The porosity of the anode 20 is about 10× less than that of the anode 20 of the first embodiment. Therefore, the flow of the fuel mixture passes by but not through the anode 20; a fuel opening 44 is provided in the second end cap 24 that is in fluid flow communication with the fuel feed channel 28 such that fuel can be fed into the fuel feed channel 28 via fuel flow opening 27 in the first end cap 23 and discharged via the fuel opening 44 (or vice versa). Catalyst material coats the inner surface of the anode 20 to promote the electrochemical reaction at the fuel feed channel side of the anode 20. This embodiment of the fuel cell 10 also differs from the first embodiment in that a second electrolyte channel 46 replaces the fuel discharge channel, and has electrolyte inlet 48 and outlet 50 for the feed and discharge of electrolyte fluid. Membrane separator 22 separates the two electrolyte channels 26 and 46.

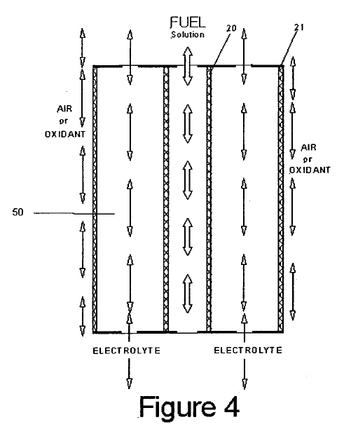

According to fourth embodiment of the invention and as illustrated in FIG. 4, the fuel cell 10 resembles the fuel cell 10 of the third embodiment (shown in FIG. 3) except that no membrane separator exists, thereby combining the two electrolyte channels in the third embodiment into one electrolyte channel 50. In this case, any leakage of methanol and gases through the anode 20 is removed by electrolyte flow. Alternatively, a separator membrane (not shown) may be located closely beside, in intimate contact with, attached to, or deposited on one or both of electrolyte-facing surfaces of the anode 20 and the cathode 21, to form separator-anode and separator-cathode assemblies, respectively. Since the membrane separators is semi-permeable (impermeable to liquid fuel and electrolyte but conductive to protons), the separator-anode assembly and/or separator-cathode assembly are also rendered semi-permeable. Another variation of this embodiment is to include a static non-circulating electrolyte between the anode 20 and cathode 21.

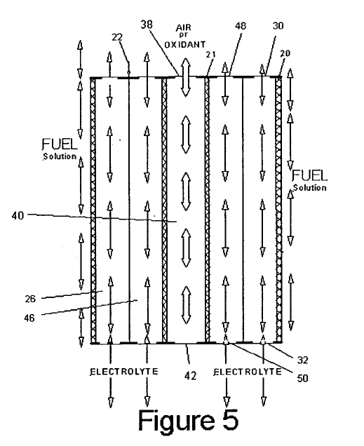

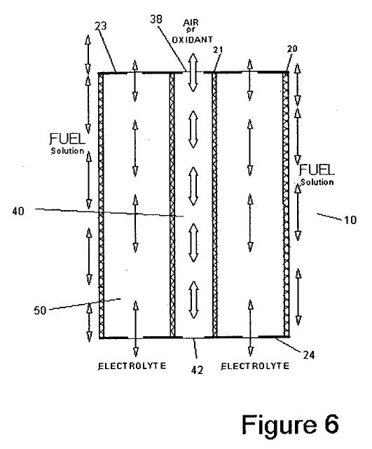

FIGS. 5 and 6 are the logical reversal of anode and cathode in the embodiments illustrated in FIGS. 3 and 4 respectively.

While the preferred embodiment of the invention has been illustrated and described, it will be appreciated that various changes can be made therein without departing from the scope and spirit of the invention. For example, a direct methanol fuel cell system as described above may have multiple tubular and concentric anodes inside the outer cathode tube, or vice versa. Another example would be to construct a fuel cell from an array of tubes in a common manifold. In addition, the tubes need not be cylindrical in cross-section; any closed tubular configuration is possible including square and hexagonal cross-sections. Also, the position of the tubes is not restricted to be concentric, but may be moved one relative to another.

A variant of the device can be used for the purpose of methanol or other fuel destruction. This is accomplished by short circuiting the anode to the cathode and flowing the methanol to be destroyed through the device. The methanol will be oxidized just as in the usual mode of operation.

What is claimed is:

1. A direct methanol fuel cell comprising
(a) a tubular inner electrode, the inside of which is a reactant conduit that is fluidly communicable with a first reactant source such that a first reactant is transmittable therethrough;
(b) a tubular outer electrode located concentrically around the inner electrode, the outside surface of which is fluidly communicable with a second reactant source such that a second reactant is transmittable over the outside surface of the outer electrode; and
(c) a tubular proton-conducting, substantially reactant-and-electrolyte-impermeable membrane separator located concentric to and between the inner and outer electrodes;
the separator membrane being spaced apart from one of the electrodes to form an annular electrolyte conduit therebetween, the electrolyte conduit being fluidly communicable with an electrolyte source such that a fluid electrolyte is transmittable therethrough; and wherein one reactant is methanol-containing fuel, and the other reactant is oxidant.

2. The fuel cell of claim 1 wherein the inner electrode is an anode, and the outer electrode is a cathode, and the first reactant is the fuel and the second reactant is the oxidant.

3. The fuel cell of claim 1 wherein the membrane separator is selected from the group of perfluorinated proton exchange membranes, microporous plastic membranes, carbon tubes, ceramic tubes, and asbestos-based membranes.

4. The fuel cell of claim 2 wherein the anode is substantially fuel permeable, the reactant conduit is a fuel feed conduit and has an inlet to receive fuel into the fuel cell and wherein the electrolyte conduit is located between the membrane separator and the cathode, and the separator membrane is spaced from the anode to form an annular fuel discharge conduit therebetween, the fuel discharge conduit having a fuel outlet to discharge permeated fuel and anode reaction products from the fuel cell.

5. The fuel cell of claim 4 wherein the fuel cell is closed to fuel flow at one end, and the fuel inlet and fuel outlet are at the other end.

6. The fuel cell of claim 2 wherein the anode is substantially fuel impermeable, and the fuel cell further comprises an annular second electrolyte conduit concentric to and between the anode and separator for the flow of a second electrolyte stream therethrough.

7. The fuel cell of claim 1 wherein the inner electrode is a cathode, and the outer electrode is an anode, and the first reactant is the oxidant and the second reactant is the methanol-containing fuel.

8. The fuel cell of claim 7 wherein the anode is substantially fuel permeable, the reactant conduit is an oxidant conduit and wherein the electrolyte conduit is between the membrane separator and the cathode, and the separator membrane is spaced from the anode to form an annular fuel discharge conduit therebetween, the fuel discharge conduit having a fuel outlet to discharge permeated fuel and anode reaction products from the fuel cell.

9. The fuel cell of claim 7 wherein the anode is substantially fuel impermeable, the reactant conduit is an oxidant conduit and wherein the electrolyte conduit is between the membrane separator and the cathode, and the separator membrane is spaced from the anode to form an annular second electrolyte conduit therebetween, the second electrolyte conduit having an electrolyte inlet and outlet.

10. A direct methanol fuel cell comprising
(a) a tubular inner electrode the inside of which is a reactant conduit that is fluidly communicable with a first reactant source such that a first reactant is transmittable therethrough;
(b) a tubular outer electrode located concentrically around the inner electrode, the outside surface of which is fluidly communicable with a second reactant source such that a second reactant is transmittable over the outside surface of the outer electrode;
(c) an annular electrolyte conduit located concentric to and in between the inner and outer electrodes, and being fluidly communicable with a fluid electrolyte source such that a fluid electrolyte is transmittable therethrough; and,
wherein one reactant is methanol-containing fuel, and the other reactant is oxidant.

11. The fuel cell of claim 10 wherein the inner electrode is an anode, and the outer electrode is a cathode, and the first reactant is the fuel and the second reactant is the oxidant.

12. The fuel cell of claim 11 further comprising a tubular proton-conducting, substantially reactant and electrolyte impermeable membrane separator located concentric to and between the anode and cathode, and wherein the electrolyte conduit is located between the separator and the cathode.

13. The fuel cell of claim 12 wherein the anode is substantially fuel permeable, the fuel conduit has an inlet for the flow of fuel into the fuel cell and the fuel cell further comprises an annular fuel discharge conduit concentric to and between the anode and the separator with a fuel outlet for the flow of permeated fuel and anode reaction products out of the fuel cell.

14. The fuel cell of claim 13 wherein the fuel cell is closed to fuel flow at one end, and the fuel inlet and fuel outlet are at the other end.

15. The fuel cell of claim 12 wherein the anode is substantially fuel impermeable, and the fuel cell further comprises an annular second electrolyte conduit concentric to and between the anode and separator for the flow of a second electrolyte stream therethrough.

16. The fuel cell of claim 11 wherein the anode is substantially fuel impermeable.

17. The fuel cell of claim 10 wherein the inner electrode is a cathode, and the outer electrode is an anode, and the first reactant is the oxidant and the second reactant is the methanol-containing fuel.

18. The fuel cell of claim 17 further comprising a tubular proton-conducting substantially reactant and electrolyte impermeable membrane separator located concentric to and between the anode and cathode, and wherein the electrolyte conduit is located between the separator and the cathode for flow of the electrolyte stream therethrough.

19. The fuel cell of claim 18 wherein the anode is substantially fuel-permeable, and the fuel cell further comprises an annular fuel discharge conduit concentric to and between the anode and the membrane separator with a fuel outlet for the discharge of permeated fuel and anode reaction products out of the fuel cell.

20. The fuel cell of claim 18 wherein the anode is substantially fuel-impermeable, and the fuel cell further comprises an annular second electrolyte conduit concentric to and between the anode and the membrane separator for the flow of a second electrolyte stream therethrough.

21. The fuel cell of claim 17 wherein the anode is substantially fuel-impermeable.

22. The fuel cell of claim 11 further comprising a substantially fuel-impermeable membrane separator attached to or deposited on the electrolyte-facing surface of the anode to form a separator-anode assembly, such that the separator-anode assembly is made substantially fuel-impermeable.

23. The fuel cell of claim 11 further comprising a substantially fuel-impermeable membrane separator attached to or deposited on the electrolyte-facing surface of the cathode to form a separator-cathode assembly, such that the separator-cathode assembly is made substantially fuel-impermeable.

24. The fuel cell of claim 17 further comprising a substantially fuel-impermeable membrane separator attached to or deposited on the electrolyte-facing surface of the anode to form a separator-anode assembly, such that the separator-anode assembly is made substantially fuel-impermeable.

25. The fuel cell of claim 17 further comprising a substantially fuel-impermeable membrane separator attached to or deposited on the electrolyte-facing surface of the cathode to form a separator-cathode assembly, such that the separator-cathode assembly is made substantially fuel-impermeable.
